(19) United States
(12) Patent Application Publication
(10) Pub. No.: US 2014/0272039 A1
(43) Pub. Date: Sep. 18, 2014

(54) REACTIVE ETHYLENE ABSORBER

(71) Applicant: MULTISORB TECHNOLOGIES, INC., Buffalo, NY (US)

(72) Inventor: George E. McKedy, Williamsville, NY (US)

(21) Appl. No.: 13/838,585

(22) Filed: Mar. 15, 2013

(51) Int. Cl. A23B 7/00; A23B 7/157; A23B 7/10

(52) U.S. Cl. CPC A23B 7/00; A23B 7/10; A23B 7/157
USPC 426/324; 252/400.1; 252/400.3

(57) ABSTRACT

This invention relates to an ethylene absorber containing at least one member selected from the group consisting of calcium hypochlorite, sodium hypochlorite, potassium hypochlorite, magnesium hypochlorite and acid and a hydroscopic material. In another embodiment, the invention relates to a method of preserving produce comprising placing the produce in a sealed package with a sealed container that allows gaseous contact with the produce in the container with an ethylene absorber comprising at least one member selected from the group consisting of potassium hypochlorite, magnesium hypochlorite, calcium hypochlorite or sodium hypochlorite; and acid and a hydroscopic material.

### STATEMENT REGARDING FEDERALLY SPONSORED RESEARCH OR DEVELOPMENT

Not applicable.

### REFERENCE TO A “SEQUENCE LISTING”

Not applicable.

### FIELD OF THE INVENTION

Invention relates to a produce preserver. The preserver absorbs ethylene, given off by produce in a package, reacts with the ethylene thereby removing the ethylene from the package atmosphere. The preferred preserver comprises calcium hypochlorite or sodium hypochlorite and citric acid.

### BACKGROUND OF THE INVENTION

Ethylene is a gas that is given off by fruits, vegetables and flowers during senescence which promotes the ripening and spoilage of the plants. Plants synthesize ethylene. Ethylene is a natural plant growth hormone which has a detrimental impact, even at low concentrations, on the product quality and shelf life of many fruits and vegetables during storage and distribution. Ethylene is sometimes referred to as the ripening or death hormone because it induces fruit ripening and accelerates fruit softening and senescence (aging). Ethylene can also cause a range of post-harvest physiological disorders such as russet spotting on lettuce and scald on apples. Although ethylene is produced by all plants, the principal sources of the low levels of ethylene in the atmosphere are climatic fruits (fruits that ripen after harvest and are characterized by an increase in respiration rate and burst of ethylene production as they ripen), damaged or rotten produce and exhaust gases. Low temperature storage reduces the formation of ethylene by lowering the respiration rate and metabolic rates of the produce. Controlled atmosphere storage with the use of low oxygen and high carbon dioxide concentrations will suppress respiration rates and render the produce less sensitive to the effects of ethylene. The best way to extend the shelf life is to reduce or eliminate the ethylene in the storage atmosphere.

Patent publications dealing with absorbing ethylene are listed as follows: U.S. Pat. No. 8,057,586 to Powers et al., dated Nov. 15, 2011; EP2044844 to Normenmacher Klaus Prof Dipl-I, dated Apr. 8, 2009; EP0311454 to Allen Davies & Co Limited, dated Apr. 12, 1989; U.S. Pat. No. 4,848,928 to Ausnit, dated Jul. 18, 1989; EP1106233 to Degussa, dated Jun. 13, 2001; EP2525173 to Whirlpool Co, dated Nov. 21, 2012; U.S. Pat. No. 8,152,902 to Wood et al., dated Apr. 10, 2012.

Packaging technologies designed to scavenge or absorb ethylene from the surrounding environment of packaged produce have been developed. The most widely used ethylene scavenging packaging technology today is in the form of a sachet containing potassium permanganate on an inert porous support such as alumina or silica gel at a level of about 5%. The ethylene is scavenged through an oxidation reaction with the potassium permanganate to form carbon dioxide and water. Although these permanganate based ethylene absorbers are effective at removing ethylene, their use is sometimes accompanied by undesirable effects. These include the possible migration of the potassium permanganate from the sachet onto the produce, lack of specificity to ethylene resulting in undesirable aromas being scalped and a general lack of enthusiasm for the use of sachets. Other types of sachet based ethylene scavenging technologies utilize activated carbon with a metal catalyst such as palladium which converts the ethylene to acetylaldehyde.

### BRIEF SUMMARY OF THE INVENTION

This invention relates to an ethylene absorber comprising at least one member selected from the group consisting of calcium hypochlorite, sodium hypochlorite, potassium hypochlorite, magnesium hypochlorite; and acid and a hydroscopic material.

In another embodiment, the invention relates to a method of preserving produce comprising placing the produce in a sealed package with a sealed container that allows gaseous contact with the produce in the container with an ethylene absorber comprising at least one member selected from the group consisting of potassium hypochlorite, magnesium hypochlorite, calcium hypochlorite or sodium hypochlorite; and acid and hydroscopic material.

### DETAILED DESCRIPTION OF THE INVENTION

The invention has numerous advantages over the prior art. The invention provides effective control of ethylene in fruit, flower, and vegetable packages. The invention is relatively low in cost and reacts rapidly enough to maintain low ethylene gas content in a fruit or other produce package. The invention may be utilized as a patch or label on the inside of the package or as a sachet. The chemicals utilized in the ethylene absorber are generally safe and low-cost. The reactants absorbed by the instant invention are safe for the user. The invention ethylene absorber will react irreversibly with ethylene and not release ethylene at a later time. The ethylene absorber invention extends the shelf life of fruit, vegetables and flowers. These advantages and others will be apparent from the detailed description below.

Suitable reactive hypochlorite materials for the invention are calcium hypochlorite, sodium hypochlorite, potassium hypochlorite and magnesium hypochlorite. The preferred reactive materials utilized in the invention ethylene absorber are calcium hypochlorite and sodium hypochlorite because they are very reactive and safe with food products. The hypochlorite materials are combined with a citric acid in a preferred embodiment and will react to form a hypochlorous acid. The hypochlorous acid reacts with ethylene gas to form chloroethanol. Generally the chloroethanol is then absorbed by a reaction products absorber. The reaction of the hypochlorous acid is generally considered to require water to be present. A hydroscopic material is generally considered necessary for the reaction to proceed. Typical hydroscopic materials are zinc chloride, sodium chloride, and sugar. Preferred hydroscopic materials are calcium and zinc chloride as they it will attract water quickly and allow the reaction to proceed.

Any acid that will react with the hypochlorite to produce the hypochlorous acid may be utilized in the invention. Suitable materials are carboxylic acid, oxalic acid, and carboxylic acids such as acetic acid, formic acid and benzoic acid. A preferred acid has been found to be citric acid as it is very effective, low in cost, safe and available in food grade.

The reaction products may be absorbed onto any suitable substrate that has efficient absorption of the reaction products. Suitable materials are activated carbon, silica gel, Chabazite, molecular sieve, and activated alumina. Activated carbon and silica gel are preferred for their ability to absorb and hold large quantities of reaction products for the weight of the material.

The hypochlorite and acid may be utilized in any combination that will react to rapidly and effectively remove ethylene. Generally, the sodium hypochlorite is in about a 10 to 15% chlorine solution. The calcium hypochlorite is dry. The quantities utilized, when used with citric acid, are typically between about equal quantities of citric acid and the sodium hypochlorite solution and up to about three times the amount by weight of hypochlorite solution as the citric acid.

The invention is a method and material for the irreversible absorption of ethylene. Activated carbon, molecular sieve and zeolites will absorb some ethylene but their capacity is limited. The preferred calcium hypochlorite or sodium hypochlorite and acid such as citric acid will react to form hypochlorous acid. Hypochlorous acid will readily react with ethylene gas to form chloroethanol. Activated carbon is added to the ethylene absorber formulation to absorb the reaction products which are primarily chloroethanol. Other absorbents such as zeolite and molecular sieve also can be sued to absorb the ethylene reaction products.

The ethylene reactive material of the invention may be placed in any suitable container in the package of vegetables, fruit, or flowers. Vegetables, fruit, and flowers will be referred to herein as produce. Typically the ethylene absorbent material is placed into a container that provides gaseous communication with the packaged produce that is intended to be protected by the absorption of ethylene. The produce package itself would be a typical packaging material that provides substantial protection from flow of water vapor and oxygen into the package. Typical package materials are nylon, polyesters, polycarbonates, and polyolefin such as polyethylene. The container for the ethylene reactive material of the invention would be a capsule, patch, or any other container suitable for placing into a package of produce. The container for the ethylene absorber would have at least one side that is in gaseous communication with the contents of the package. Sachets formed of microporous material such as Tyvek® and other spun bonded or stretched microporous material are known for use in sachets for food and medicine packaging. The absorbent may be placed in a label or patch that would be adhesively placed on the inside of the container where it would not be loose with the produce. The formation of sachets, patches and labels is known in the art.

The following examples are illustrative and not exhaustive of ways of practicing the invention. Parts and percentages are by weight unless otherwise indicated. The moisture source is 2.5 g of water on blotter paper that is placed into the pouch. In actual use, with produce, water would not be necessary as the produce would provide water.

### Example 1

0.4 grams calcium hypochlorite

0.4 grams citric acid

0.4 grams anhydrous calcium chloride

The above blend was mixed together and placed in a 15 liter pouch containing 100 ppm of ethylene gas in air with a 2.5 gram moisture source. This formulation reduced the ethylene content at room temperature from 100 ppm to 1.0 ppm within 7 days. The analysis was conducted by gas chromatography.

### Example 2

0.2 grams calcium hypochlorite

0.2 grams citric acid

0.2 grams anhydrous calcium chloride

The above blend was mixed together and placed in a 15 liter pouch containing 100 ppm of ethylene gas in air with 2.5 gram moisture source. This formulation reduced the ethylene content at room temperature from 100 ppm to 50 ppm within 10 days. The analysis was conducted by gas chromatography.

### Example 3

1.0 grams sodium hypochlorite solution (10-15% chlorine)

2.4 grams silica gel, B type

0.4 grams citric acid

0.4 grams anhydrous calcium chloride

The above blend was mixed together and placed in a 15 liter pouch containing 100 ppm of ethylene gas in air with 2.5 gram moisture source. This formulation reduced the ethylene content at room temperature from 100 ppm to 3 ppm within 10 days. The analysis was conducted by gas chromatography.

### Example 4

0.4 grams calcium hypochlorite

0.4 grams citric acid

0.4 grams anhydrous calcium chloride

The above blend was mixed together and placed in a 15 liter pouch containing 100 ppm of ethylene gas in air with 2.5 gram moisture source. This formulation reduced the ethylene content from 100 ppm to 11 ppm within 2 days at 10° C. The analysis was conducted by gas chromatography.

### Example 5

0.8 grams calcium hypochlorite

0.8 grams citric acid

0.8 grams anhydrous calcium chloride

The above blend was mixed together and placed in a 15 liter pouch containing 100 ppm of ethylene gas in air with 2.5 gram moisture source. This formulation reduced the ethylene content from 100 ppm to 2 ppm within 2 days at 10° C. The analysis was conducted by gas chromatography.

### Example 6

1.0 grams sodium hypochlorite solution (10-15% chlorine)

2.4 grams silica gel, B type

0.4 grams citric acid

0.4 grams anhydrous calcium chloride

The above blend was mixed together and placed in a 15 liter pouch containing 100 ppm of ethylene gas in air with 2.5 gram moisture source. This formulation reduced the ethylene content from 100 ppm to less than 1 ppm within 2 days at 10° C. The analysis was conducted by gas chromatography.

### Example 7

2.0 grams sodium hypochlorite solution (10-15% chlorine)

4.8 grams silica gel, B type

0.8 grams citric acid

0.8 grams anhydrous calcium chloride

The above blend was mixed together and placed in a 15 liter pouch containing 100 ppm of ethylene gas in air with 2.5 gram moisture source. This formulation reduced the ethylene content from 100 ppm to less than 1 ppm within 2 days at 10° C. The analysis was conducted by gas chromatography.

### Example 8

0.4 grams calcium hypochlorite
0.4 grams citric acid
0.4 grams anhydrous calcium chloride
3.0 grams St. Cloud 14×50 chabazite dried at 120° C. for 18 hours

The above blend was mixed together and placed in a 15 liter pouch containing 100 ppm of ethylene gas in air with 2.5 gram moisture source. This formulation reduced the ethylene content from 100 ppm to 10 ppm within 2 days at 10° C. The analysis was conducted by gas chromatography.

### Example 9

0.4 grams calcium hypochlorite

0.4 grams citric acid

0.4 grams anhydrous calcium chloride

4.0 grams activated alumina UOP D201 7×12

The above blend was mixed together and placed in a 15 liter pouch containing 100 ppm of ethylene gas in air with 2.5 gram moisture source. This formulation reduced the ethylene content from 100 ppm to 11 ppm within 2 days at 10° C. The analysis was conducted by gas chromatography.

### Example 10

0.4 grams calcium hypochlorite

0.4 grams citric acid

0.4 grams anhydrous calcium chloride

2.0 grams silica gel, type B

The above blend was mixed together and placed in a 15 liter pouch containing 100 ppm of ethylene gas in air with 2.5 gram moisture source. This formulation reduced the ethylene content from 100 ppm to less than 1 ppm within 2 days at 10° C. The analysis was conducted by gas chromatography.

### Example 11

0.4 grams calcium hypochlorite

0.4 grams citric acid

0.4 grams anhydrous calcium chloride

0.5 grams 13× molecular sieve

The above blend was mixed together and placed in a 15 liter pouch containing 100 ppm of ethylene gas in air with 2.5 gram moisture source. This formulation reduced the ethylene content from 100 ppm to 2 ppm within 2 days at 10° C. The analysis was conducted by gas chromatography.

### Example 12

0.4 grams calcium hypochlorite

0.4 grams citric acid

0.4 grams anhydrous calcium chloride

0.5 grams 13× molecular sieve

The above blend was mixed together and placed in a 15 liter pouch containing 100 ppm of ethylene gas in air with 2.5 gram moisture source. This formulation reduced the ethylene content from 100 ppm to 10 ppm within 2 days at 10° C. The analysis was conducted by gas chromatography.

### Example 13

0.4 grams calcium hypochlorite
0.4 grams citric acid
0.4 grams anhydrous calcium chloride
0.5 grams St. Cloud 14×50 chabazite dried at 120° C. for 18 hours

The above blend was mixed together and placed in a 15 liter pouch containing 100 ppm of ethylene gas in air with 2.5 gram moisture source. This formulation reduced the ethylene content from 100 ppm to 2 ppm within 2 days at 10° C. The analysis was conducted by gas chromatography.

### DISCUSSION OF EXAMPLES

It was determined that the primary reaction product of ethylene gas and the hypochlorous acid is chloroethanol. The hypochlorous acid is formed by the reaction of the calcium hypochlorite or sodium hypochlorite and an acid such as citric acid. Absorbents were added to the reaction blend to absorb these reaction products. The absorbents tested were activated carbon, silica gel, chabazite, 13× molecular sieve and activated alumina.

The Examples all illustrate the effectiveness of the invention materials for removing ethylene from the atmosphere of a package in a rapid and irreversible manner.

1. An ethylene absorber comprising at least one member selected from the group consisting of calcium hypochlorite, sodium hypochlorite, potassium hypochlorite, magnesium hypochlorite; and acid and a hydroscopic material.

2. The ethylene absorber of claim 1 wherein the hydroscopic material comprises zinc chloride.

3. The ethylene absorber of claim 2 wherein the hydroscopic material comprises anhydrous calcium chloride.

4. The ethylene absorber of claim 1 wherein the hydroscopic material is selected from the group consisting of zinc chloride, sodium chloride and sugar.

5. The ethylene absorber of claim 1 further comprising a reaction products absorber.

6. The ethylene absorber of claim 5 wherein the reaction products absorber is selected from the group consisting of activated carbon, silica gel, Chabazite, molecular sieve, and activated alumina.

7. The ethylene absorber of claim 6 wherein the reaction products absorber comprises activated carbon.

8. The ethylene absorber of claim 1 wherein the acid comprises citric acid.

9. The ethylene absorber of claim 1 wherein the acid comprises carboxylic acid.

10. The ethylene absorber of claim 1 wherein the acid comprises at least one member selected from the group consisting acetic acid, formic acid and benzoic acid.

11. The ethylene absorber of claim 1 wherein the acid comprises oxalic acid.

12. The ethylene absorber of claim 11 wherein the acid is citric acid, the hydroscopic material comprises anhydrous calcium chloride, and activated carbon absorber is present as a reaction products absorber.

13. A method of preserving produce comprising placing the produce in a sealed package with a sealed container that allows gaseous contact with the produce in the container with an ethylene absorber comprising at least one member selected from the group consisting of potassium hypochlorite, magnesium hypochlorite, calcium hypochlorite or sodium hypochlorite; and acid and hydroscopic material.

14. The method of claim 13 wherein the hydroscopic material comprises zinc chloride.

15. The method of claim 14 wherein the hydroscopic material comprises anhydrous calcium chloride.

16. The method of claim 13 wherein the hydroscopic material is selected from the group consisting of zinc chloride, sodium chloride and sugar.

17. Method of claim 13 wherein the container further comprises a reaction products absorber.

18. Method of claim 17 wherein the reaction products absorbers are selected from the group consisting of silica gel, zeolite such as chabazite, molecular sieve and activated carbon.

19. Method of claim 17 wherein reaction products absorber comprises activated carbon.

20. The method of claim 13 wherein the container comprises a sachet with at least one wall that is permeable to gases and impermeable to liquids.

21. The method of claim 13 wherein the container comprises a label or patch that has at least one side permeable to gases and impermeable to liquids.

22. The method of claim 21 wherein the label or patch is attached to the inside of the sealed package.

23. Method of claim 13 wherein fruit is in the package.

24. The method of claim 11 wherein the acid comprises citric acid.

25. The method of claim 11 wherein the acid comprises carboxylic acid.

26. The method of claim 11 wherein the acid comprises at least one member selected from the group consisting acetic acid, formic acid and benzoic acid.

27. The method of claim 13 wherein the acid comprises oxalic acid.

28. The method of claim 14 wherein the acid is citric acid, the hydroscopic material comprises anhydrous calcium chloride and the ethylene absorber comprises a reaction products absorber further comprising activated carbon.
